(19) United States
(12) Patent Application Publication
(10) Pub. No.: US 2013/0326249 A1
(43) Pub. Date: Dec. 5, 2013

(54) REGULATING POWER CONSUMPTION OF A MASS STORAGE SYSTEM

(71) Applicants: Guillermo Navarro, Boise, ID (US); David Umberger, Boise, ID (US); John J. Sengenberger, Meridian, ID (US); Milos Manic, Idaho Falls, ID (US)

(72) Inventors: Guillermo Navarro, Boise, ID (US); David Umberger, Boise, ID (US); John J. Sengenberger, Meridian, ID (US); Milos Manic, Idaho Falls, ID (US)

(21) Appl. No.: 13/981,903

(22) PCT Filed: Jun. 9, 2011
(86) PCT No.: PCT/US11/39742

§ 371 Date: Jul. 25, 2013

(51) Int. Cl. G06F 1/32

(52) U.S. Cl. CPC G06F 1/329
USPC 713/320

(57) ABSTRACT

A technique includes receiving first work requests that are associated with a user workload. The technique includes using a machine to transform the first work requests into second work requests that are provided to components of a mass storage system to cause the components to perform work associated with a workload of the mass storage system; and regulating a power consumption of the mass storage system, including regulating a rate at which the second work requests are provided to the components of the mass storage system.

### BACKGROUND

Many companies are currently spearheading initiatives to reduce power consumption for such purposes as reducing costs and becoming more environmentally responsible. Because a typical company may employ one or multiple disk arrays to store data and the operation of the disk array(s) typically consume a considerable amount of power, reducing the array(s)' power consumption may be consistent with such initiatives.

One way to manage the power that is consumed by a disk array involves placing one or more of the disk array's components a relatively lower power consuming state (as compared to a higher power consuming “normal” base state) or completely powering down components of the array when the components are not processing work for the array. Switching on and off components of the disk array typically introduces processing delays due to the waiting time for powered down components to once again become operational. For example, when a mechanical drive (i.e., a typical array component) powers up, a delay is incurred waiting for the platters of the drive to spin up to their operating speeds. The spin up time of a typical mechanical drive may be on the order of tens of seconds before the drive becomes ready to serve input/output (I/O) requests.

### BRIEF DESCRIPTION OF THE DRAWING

FIG. 1 is a schematic diagram of a computer system according to an example implementation.

FIGS. 2 and 4 are flow diagrams depicting techniques to regulate power consumption of a mass storage system according to example implementations.

FIG. 3 depicts an architecture to manage the flow of work requests from the user to the mess storage array according to an example implementation.

### DETAILED DESCRIPTION

Concern over the growing power consumption in data centers has increased over the past several years. As customer capacity requirements have been increasing, so has the energy that is consumed to satisfy these requirements. Increased energy requirements generally translate into increased costs in operating the data centers. These concerns, along with “green” initiatives, have led to new initiatives for the development of more energy efficient servers, storage products, and other components used in the data centers.

Systems and techniques are disclosed herein, which regulate the rate at which work requests are processed by the work performing components (drives, for example) a mass storage system for purposes of reducing the energy that is consumed by the system. More specifically, as disclosed herein, the power consumption of the mass storage system is regulated through the modulation of the rate at which work requests are provided to the work performing components of the mass storage system; and in general, the techniques and systems that are disclosed herein are applicable to controlling any component of a mass storage system whose power consumption is function of the workload demand that is placed on it.

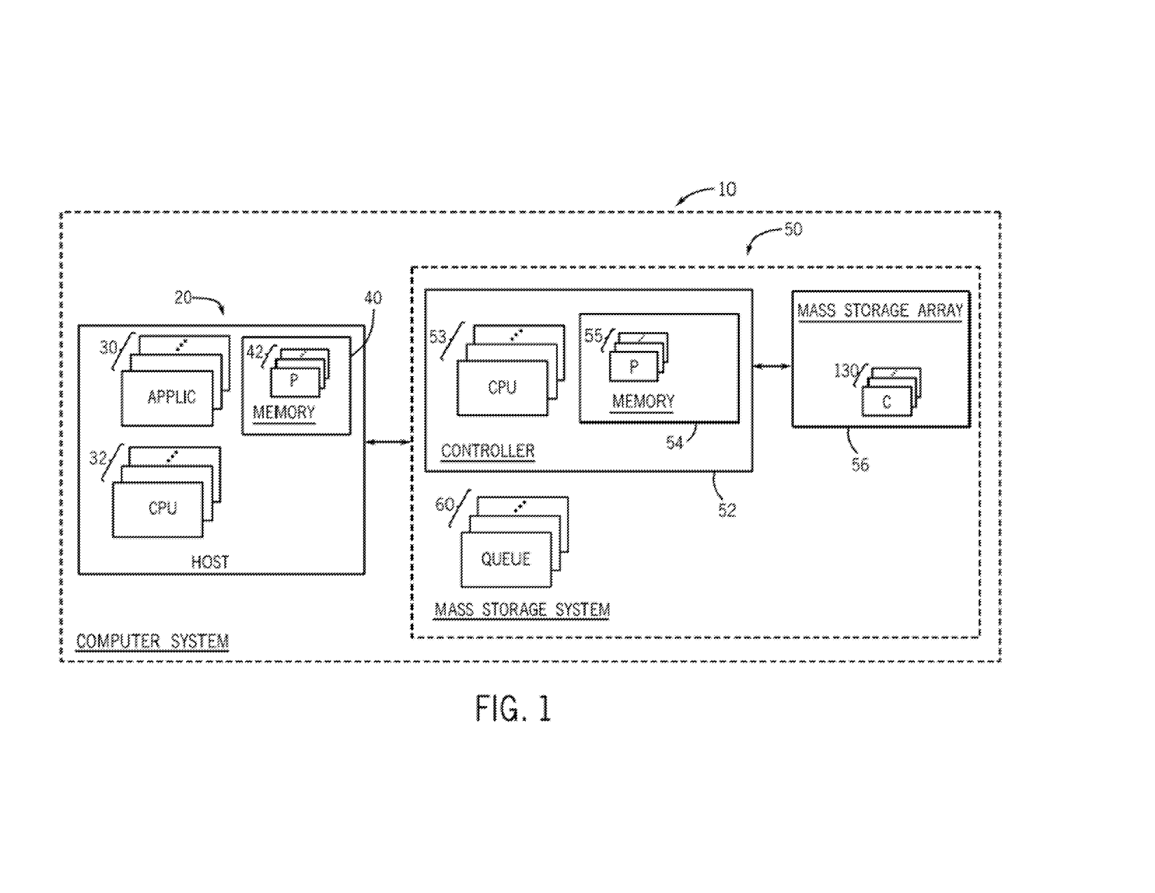

As a more specific example, FIG. 1 depicts an exemplary computer system 10 in accordance with some implementations. In general, the computer system 10 includes a host computer 20, which is a physical machine that generates work requests (i.e., input/output (I/O) requests) for a given user workload. It is noted that, depending on the particular implementation, the computer system 10 may contain more than one host computer 20. The host 20 includes one or more multiple central processing units (CPUs) 32, which execute machine executable instructions to create, for example, one or more applications 30 that generate the work requests.

In general, the work requests are communicated to a mass storage system 50 and are temporarily stored in priority queues 60 of the system 50. When processed by the mass storage system 50, the work requests cause components 130 (mechanical drives, sold state drives, etc.) of a storage array 56 of the mass storage system 50 to perform work (read and write operations, for example) to fulfill the work requests. Mora specifically, a disk array controller 52 of the mass storage system 50 transform the work requests that are stored in the priority queues 60 into corresponding work requests for the components 130 of mass storage array 56. As described further below, the rate at which the work requests are processed by the array's components 130 is controlled, or regulated, for purposes of regulating the overall that is power consumed by the mass storage system 50. This regulation involves controlling the rates at which work requests are released from the priority queues 60 as well as controlling the transformations that are performed by the controller 52.

As depicted in FIG. 1, in accordance with exemplary applications, the host computer 20 contains a memory 40 that stores machine executable instructions that are execute by the CPU(s) 32 for purposes of generating the user work requests for the components 130 of the mass storage array 56. Likewise, the controller 52 may contain a memory 54 to store one or multiple sets of machine executed by one or multiple CPUs 53 of the controller 52 to cause the controller 52 to perform the techniques that are disclosed herein. The memories 40 and 54 am non-transitory memories, such as semiconductor memories, optical storage memories, magnetic storage memories, removable media memories, etc. In accordance with other exemplary implementations, the controller 52 may be formed from non-processor-based hardware or from a combination of non-processor-based hardware and processor-based hardware. Thus, many possible implementations are contemplated and are within the scope of the appended claims.

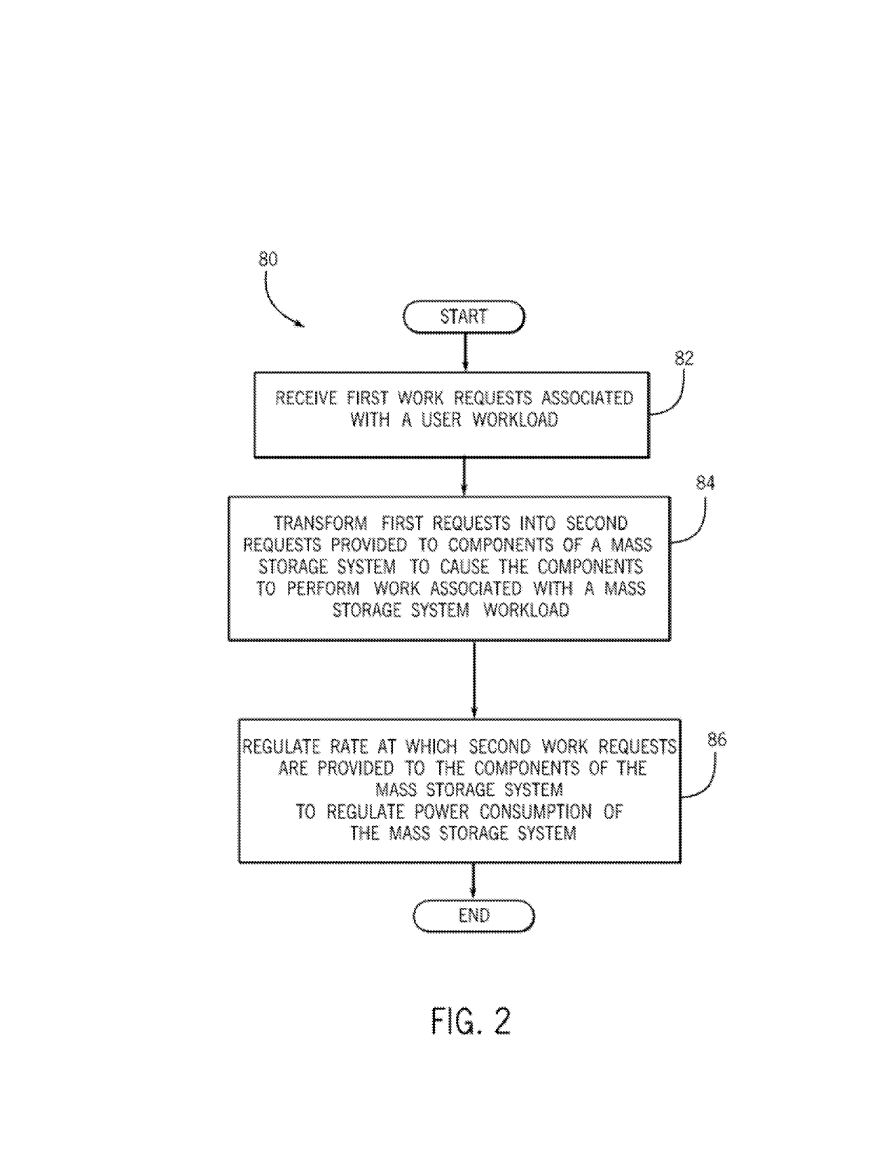

Referring to FIG. 2, in accordance with example implementations, the mass storage system 50 may perform a technique 80 for purposes of regulating its power consumption. The technique 80 includes receiving (block 82) first work requests that are associated with a user workload and transforming (block 84) the first requests into second requests, which are associated with a mass storage system workload. The technique 80 further includes regulating (block 86) the rate at which the second work requests are provided to the mass storage system to regulate power consumption of the mass storage system.

As a more specific non-limiting example, it may be assumed for the following discussion that a work request (called “w(t, p)” herein) is received by, or “arrives” at a given disk array component at time t, where “p” represents a set of parameters that 1.) completely define the work to be done; 2.) may include information about the source, such as a host bus adapter (HBA) world-wide name, the identity of an initialing host computer, or the identity application making the request; and 3.) may associate a relative priority to the request. Information defining the work to be done by the disk array component may include an operational instruction (or “opcode”), data identifying a target LU (logical unit), a target offset into the target LU (address in the storage space), and a block size. Information on the relative priority of the work request may contain indicators to indicate how important performance is compared to the energy consumption associated with fulfilling the request.

The work requests arrive in a time-ordered fashion: the first request arrives at a time t₁, the second request arrives at a time t₂, and the k^{th} time arrives at time tₖ, with tₖ≦tₖ₊₁. The use of the inequality acknowledges that more than one request may arrive at the same time or at different times that are indistinguishable from each other because of limited resolution of the “clocks” being used to measure time. In such a case the labeling of these indistinguishable times is arbitrary and may be chosen in any manner.

The times tₖ are called arrival times, and the set of integers that label them is an index set called “I” herein. Defining “N” to represent the set or natural numbers, the index set I may be described as follows:

I={i⊂N:∀i,j∈N,i≧j=>tᵢ≧tⱼ} Eq. 1

The index set I may be used to label work requests and their parameter sets p as well. If a work request w(t,p) arrives at a time tₖ, the request has an associated fixed set of parameters called “pₖ” and may be defined as follows:

wₖ≡w(tₖ,Pₖ). Eq. 2

The workload (called “W”) is the time ordered sequence of work requests:

W={wᵢ:k∈I} Eq. 3

In general, the workload W is the entire workload arriving at a component that services the requests of the workload W.

The workload W has subsets, such that each subset is a time-ordered sequence of work requests. One or more elements of the parameter set associated with each work request in W may be used to classify the work requests of W and assign them to one of its subsets. For the purposes of this discussion, the most useful classifications result in disjoint subsets of W. More specifically, a classification scheme that results in a total of N_{W} work requests may be defined as follows:

Wᵢ⊂W

for

i=1, . . . , N_{W}, Eq.4

Wᵢ∩WⱼØ

for

1≠j, Eq. 5

and

∪ᵢ₋₁^{N}^{_{W}}Wᵢ=W, Eq. 6

where “Wᵢ” represents subworkloads of workload W.

A component C is subjected to the workload W for a total time T. The component C processes a subworkload Wᵢ⊂W such that 1.) C consumes energy to operate; and 2.) C processes the requests in Wᵢ. It is assured that the components C may consume energy in their idle states, i.e., when the components C are not actively doing work to process any work requests. In an actual disk array, many such components, such as disk drives, consume more energy when they are actively processing a work request than when they are idle.

In the following discussion, “eᵢⱼ” represents the total energy consumed by the component C when processing the work request wᵢⱼ∈Wᵢ. Based on this definition, the amount of energy consumed by all the work requests in Wᵢ may be described as follows:

$${E}_{i} = {\sum }_{j = 1}^{{N}_{i}} {e}_{ij} , \\ and \qquad Eq . 7$$

the power consumed by C in processing the requests of Wᵢ during the time T may be described as follows:

$${P}_{i} \approx \frac{{E}_{i}}{T} = \frac{{\sum }_{j = 1}^{{N}_{i}} {e}_{ij}}{T} . \qquad Eq . 8$$

The average amount of energy consumed per work request ēᵢ may be described as follows:

$${\overline{e}}_{i} = \frac{{\sum }_{j = 1}^{{N}_{i}} {e}_{ij}}{T} , \qquad Eq . 9$$

where “Nᵢ” represents the total number of requests in Wᵢ, as described below:

W₁=∪ⱼ₋₁^{N}^{₁}wᵢⱼ. Eq. 10

The average arrival rate (called “λᵢ”) for the subworkload Wᵢ (a measure of Wᵢ's demand on C) may be described as follows:

$${λ}_{i} = \frac{{N}_{i}}{T} . \qquad Eq . 11$$

Given this definition and Eqs. 8 and 9, the average power (called “Pᵢ”) consumed by C in processing Wᵢ may be described as follows:

Pᵢ≈ e̅ᵢ̅λᵢ, Eq. 12

and the power P consumed by W may be described as follows:

$$P = {\sum }_{i = 1}^{{N}_{x}} {P}_{i} \qquad Eq . 13$$

Under steady-state conditions, the arrival rate λᵢ is equal to the throughput being delivered by the array. This means that the power consumption is directly proportional to the rate with which the array processes the requests of W. Slowing down this processing results in less consumed power, given that ēᵢ does not depend on λ. Therefore, the potential exists for regulating the power consumption of an array component by regulating the rate at which work requests are processed by the array. This statement holds even when ēᵢ depends explicitly on λ. An example of such a component is a magnetic disk drive that uses a seek reordering algorithm to minimize disk service times. The condition that is satisfied is that Pₖ is a definite function of λ.

Therefore, the quantify λ may be considered to be a processing rate rather than an arrival rate. There is no loss of generality with respect to this change because this change is effected by changing the definition of the times tᵢ and tⱼ in Eq. 1, above, to be the time at which the work requests wᵢ and wⱼ have completed being processed by the component Cₖ.

Regulation of the processing of the work items of W may be viewed as managing a tradeoff between storage performance and power consumption. In cases where Pₖ is a monotonically increasing function of λ, power consumption may be reduced by reducing the processing rate λ. This implies that the array yields a lower throughput (work request completion rate) for W and, potentially, a higher average response time (average time that a work request is resident in the array). In cases where power consumption is more important to a customer than performance, such a reduction of the processing rate may not only be acceptable but in fact desirable.

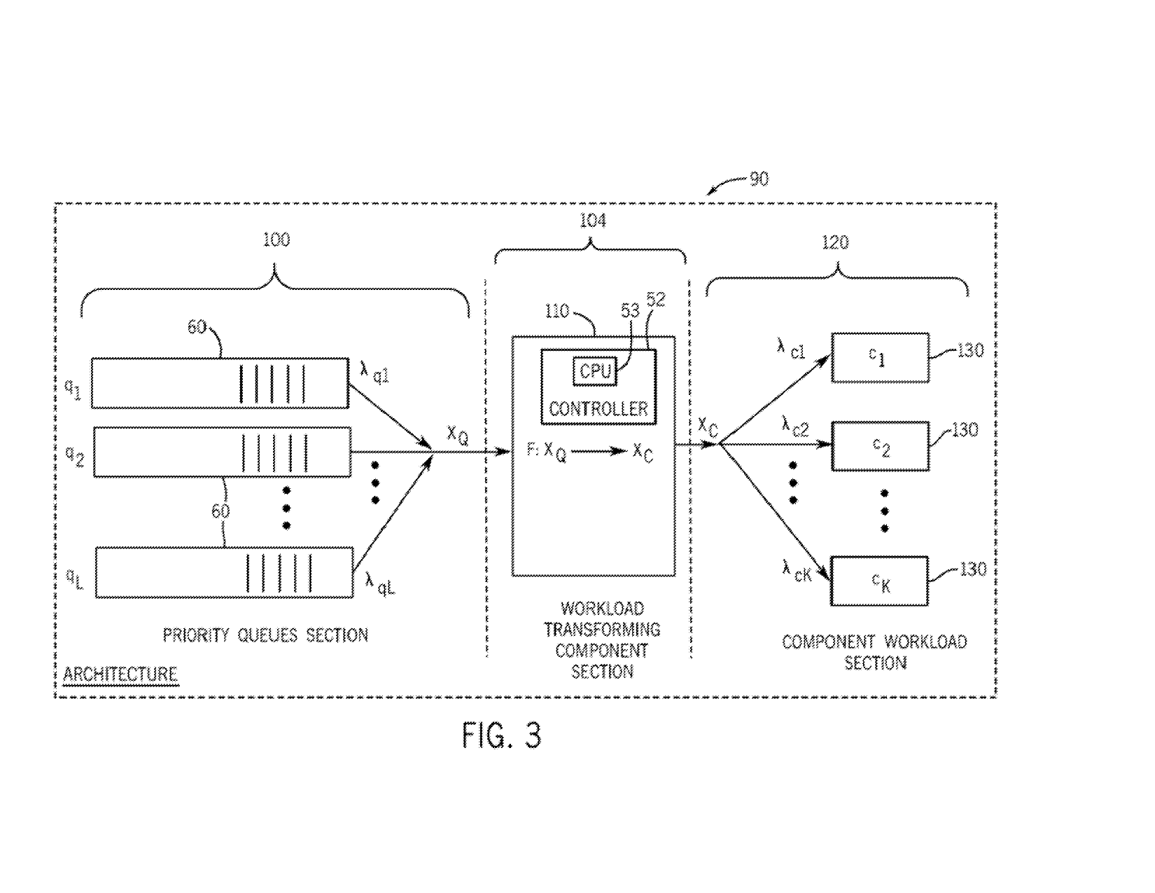

One way to regulate th processing rate λ is by assigning priorities to the queues 60. More specifically, referring to FIG. 3 in conjunction with FIG. 1, in accordance with an example implementation, the disk array controller 52 may employ an overall architecture 90 for processing the work requests. The architecture 90 may be subdivided into a first priority queues section 100 (formed in part by the queues 60); a second, workload transforming section 104 (which includes a workload transforming component 110); and a third component workload section 120, which includes the components 130 of the mass storage array 56. As a non-limiting example, the sections 100 and 104 of the architecture 90 may be formed from components of the disk a array controller 52, such as the queues 60 and the CPUs 53. As more specific examples, depending on the particular implementation, the workload transforming component 110 may be formed by the disk array controller 52, one or multiple CPUs 53, etc.

As a non-limiting example, the first section 100 is associated with the user data workload for logical units (LUNs). The third section 120 includes such components 130 as hard disk drives (HDDs), sold state drives (SSDs), or a combination of such devices. The workload transforming season 104 transforms the user data workload associated with the section 100 to the component workload associated with the section 120.

As described above, a workload may be divided in sub workloads, and the priority queues scheme is based on the decomposition of the user data workload in a set of queues as described below:

W=∪ᵢ₌₁^{L}qᵢ, Eq. 14

where “L” represents the number of queues (q) 60 in which the user data workload is divided into. And as shown in Eq. 9, each sub workload is composed of a number of requests. Each queue qᵢ contains a number N_{qi} of requests wᵢⱼ, as described below:

qᵢ=∪ⱼ₋₁^{Nqi}wᵢⱼ. Eq. 15

The user data requests that make up the data workloads arrive first at the priority queues sections 100. The requests are classified according to some criteria. For example, the requests can be enqueued according to target LUN, Fibre Channel World Wide Node, or some priority scheme for requests. The requests are stored in one of the queues (qᵢ) 60, according to the classification criteria. For the purpose of the following description, it is assumed that all arriving user requests are classified and enqueued in one of the qᵢ queues 60.

A consideration for the design of a control system is the time scale of the events to control and the response time expected from the control system. The regulation of the power consumption is based on the regulation of the rate at which the requests stored in the queues (q) 60 are processed by the workload transforming component 110. A sampling time of T is used to measure the processing rate for all queues. The processing rate of each queue qᵢ is the number W_{qi} of requests processed during time T, as described below:

$${λ}_{qi} = \frac{{\sum }_{j = 1}^{{W}_{qi}} {w}_{ij}}{T} . \qquad Eq . 16$$

The sum of the processing rates from all of the queues (q) 60 is the total processing rate applied to the workload transforming component 110, as described below:

$${X}_{Q} = {\sum }_{i = 1}^{L} {λ}_{qi} . \qquad Eq . 17$$

There is a maximum processing rate X_{Q}^{max} that the workload transforming component 110 can process. Therefore the total processing rate is X_{Q}≦X_{Q}^{max}.

Thus, λ_{qi} is regulated for purposes of regulating the power consumption of the component (cᵢ) 130. As described further below, the control of the processing rate λ_{qi} of each queue (q) 60 controls the power consumption of the components (cᵢ) to be controlled. The processing rate λ_{qi} for each queue (q) 60 may be controlled using a closed-loop scheme for the release of work requests to the workload transforming component 110. The processing rate (throughput) of each closed loop queue may be described as follows:

$${λ}_{qi} = \frac{{N}_{qi}}{{r}_{i} + {z}_{i}} , \qquad Eq . 18$$

where “rᵢ” represents the response time of the requests released from qᵢ; and “zᵢ” represents the think time of the same queue (q) 60. The think time zᵢ is the delay in between requests and may be used as a “knob” to throttle the release of work requests to the workload transforming component 110. The think time zᵢ is used for the regulation of the power consumption by regulating the processing rate that the components (cᵢ) 130 will serve. Therefore, λ_{qi} is a function of the control input zᵢ, which can be expressed as λ_{qi}=f(zᵢ). In terms of control theory, the response time rᵢ is a state variable, and the zᵢ is a control input. Each queue (qᵢ) 60 may have its corresponding think time zᵢ. The set of all think times is a vector called “Z=(z₁,z₂ . . . , z_{L}),” with L elements, where “L” represents the number of queues 60 where each element Zᵢ is greater than zero. The sum of all processing rates may be described as follows:

$${X}_{Q} = {\sum }_{i = 1}^{L} {λ}_{qi} ( {z}_{i} ) . \qquad Eq . 19$$

Eq. 19 describes the throughput delivered to the workload transforming component 110. The workload transforming component 110 receives the processing rates from the priority queues 60 and changes the processing rates according to some function or rule. As a on-limiting example, in the case of a disk array, the workload transforming component 110 may transform the number of work requests for writing data based on the Raid level of the LUN to be written. As an example, if the Raid Level of the LUN to be accessed (read or writes) is using RAID1 redundancy, then the workload transforming component 110 transforms the work requests to that LUN. The work requests may be described using Eq. 2 as the original notation and describing the parameters (pₖ) part of the work request, as follows:

wₖ=w(tₖ,accessₖ,size,ₖLUNₖ). Eq. 20

The workload transforming component 110 processes the requests from the queues (q) 60 according to a function for the Raid1 redundancy level, which is called “f_{R1}” herein. For both reads and writes, the work request is targeted at one of the regulated components c₁, . . . , cₖ, as follows:

$${f}_{RI} : {w}_{k} ( {p}_{k} ) \to {w}_{k}^{′} , \\ where \\ {w}_{k}^{′} = \{ \begin{matrix}if {access}_{k} == read \\ {w}_{k}^{′} = {w}_{k} ( {t}_{k}^{′} , {access}_{k} , {size}_{k} , {LUN}_{k} , {c}_{m} ) \\ if {access}_{k} == write \\ {w}_{k}^{′} = < {w}_{k , 1} , {w}_{k , 2} > \\ {w}_{k , 1}^{′} = {w}_{k} ( {t}_{k}^{′} , {access}_{k} , {size}_{k} , {LUN}_{k} , {c}_{m} ) \\ {w}_{k , 2}^{′} = {w}_{k} ( {t}_{k}^{′} , {access}_{k} , {size}_{k} , {LUN}_{k} , {c}_{n} )\end{matrix} \} . \qquad Eq . 21$$

The RAID1 level function of Eq. 21 adds the target component for a specific request Wₖ, and that request is now is transformed into a request w′ₖ. The component cₘ serves the request w′ₖ.

Assuming for simplicity that all LUNs in a disk array are using RAID1 redundancy, then the workload transforming component 110 transforms the workload from the priority queues (q) 60 according to the following workload transforming function:

f_{R1}:W→W′, Eq. 22

where “W′” represents the total workload from the priority queues (q) as defined in Eq. 14, and the “W′” represents the total workload is delivered to all regulated components c₁ . . . cₖ. The workload is a different workload in terms of the number of requests because the number of requests for write accesses coming from the priority queues side generates two requests on the regulated components side.

The W′ workload is delivered to the K components (c) 130, where each component will process the work requests w′ₖ at a processing rate determined by two factors: 1) the processing rate the regulated component (c) 130 can deliver; and 2) the rate at which the work requests are delivered to the regulated components (c) 130 by the priority queues (q) 60. The first factor, the service time of the component (c) 130, is an intrinsic characteristic of the device. For example, the component (c) 130 may be a magnetic or solid state disk.

The second factor, the regulation of work requests, determines the processing rate of the components (c) 130. Therefore, by controlling one of these factors mentioned, namely the second factor, the processing in the components c₁ . . . cₖ, may be regulated. With the W′ workload defined, below is a discussion regarding how the components c₁ . . . cₖ are utilized. As shown in FIG. 3, there are K components, which allows to decompose the workload W′ as follows;

W′=∪ᵢ₋₁^{K}cᵢ, Eq. 23

Eq. 23 is the equivalent to Eq. 14 but now on the regulated components side. For each component cᵢ its workload may be decomposed by a number of N_{ci} individual requests w′ⱼ as follows:

cᵢ=∪ⱼ₌₁^{Nci}w′ᵢⱼ, Eq. 24

The processing rate of each component cᵢ is the number W_{ci} of requests processed during time T by the component, as described below:

$${λ}_{ci} = \frac{{\sum }_{j = 1}^{{W}_{ci}} {w}_{ij}^{′}}{T} . \qquad Eq . 25$$

The sum of the processing rates from all components (c) 130 is the total processing rate on the component side. This total processing rate, X_{c}, comes from the workload transforming component section 104, as described below:

$${X}_{C} = {\sum }_{i = 1}^{K} {λ}_{ci} . \qquad Eq . 26$$

The total processing rate on the regulated components (c) 130 is derived from the workload transforming component 110, which delivers a processing rate X_{WTC}. This processing rate X_{WTC} is bounded by the maximum processing rate that the workload transforming component 110 may deliver, or X_{WTC}^{max}. Therefore the total processing rate is X_{C}≦X_{WTC}^{max}. The throughput in cᵢ determines the power consumed by cᵢ,P_{ci} as shown in Eq. 12 and applied to the components (c) 130 to be regulated, as described below:

P_{ci}(λ_{ci})=ēᵢⱼλ_{ci}. Eq. 27

The term ēᵢⱼ is the average energy required to process request the w′ᵢⱼ processes as in Eq. 25 during the time T by the component cᵢ. The total power consumed by the K components (c) 130 may then be described as follows:

$$P = {\sum }_{i = 1}^{K} {P}_{ci} , \qquad Eq . 28$$

To summarize, there are two possible ways to regulate power consumption in a mass storage system, as described above: 1) control the processing rate of the work requests in the priority queues so the total processing rate to the workload transforming component 110 is controlled (which is referred to below as “Alternative 1”); and 2) control the processing rate of the workload transforming function that produces the workload to the regulated components is controller (which is referred to below as “Alternative 2”). Eq. 22 is an example of such workload transforming function. These power consumption regulation techniques may be applied separately or in combination, depending on the particular implementation.

Alternative number one may be achieved by setting the think time of each queue 60; and alternative number two may be achieved by throttling the processing rate of the workload transforming function. The workload transforming function may be described as follows:

F_{WTC}:∪ᵢ₌₁^{L}qᵢ→∪ᵢ₌₁^{K}cᵢ, Eq. 29

Each queue (qᵢ) 60 has its processing rate as shown in Eq. 16. As shown by Eq. 18, the think time zᵢ that may be regulated and also determines the result λ_{qi}. Another form of Eq. 29 may be obtained by providing a function representation that is more detailed and includes all priority queues and components. First, the set of queue processing rates for all priority queues L is defined as a vector:

V_{L}(z)=[λ_{q1}(z₁), λ_{q2}(z₂), . . . , λ_{qL}(z_{L})]. Eq. 30

The vector z=[z₁z₂, . . . , z_{L}] is the set of all think times for all of the L queues. The set with the components' processing rates is also a vector, as described below:

V_{K}=[λ_{c1}, λ_{c2}, . . . , λ_{cK}]. Eq. 31

Equations 30 and 31 provide the final approach to understand the workload transformation that regulates the power consumption. The workload transforming component 110 makes a transformation on the workload from the queues in terms of a vectorial space transformation. The space of throughput of L queues is transformed into the space of throughput with K components, as described below:

F_{WTC}:V_{L}(z)→V_{K}, Eq. 32

where each λ_{qi} ∈V_{L} is an element of the subspace V_{L}; and “V_{L}” represents the subspace with the set of all L-tuples λ_{qi} subject to the constraint X_{Q}≦X_{Q}^{max}. And each λ_{ci} ∈V_{K} is an element of the subspace V_{K}, which is the subspace with the set of all K-tuples λ_{ci}, subject to the constraint X_{C}≦X_{WTC}^{max}. The transformation from the input throughput to the workload transforming component to the output component throughput may be expressed in a similar fashion as Eq. 32:

F_{WTC}:X_{Q}(z)→X_{C}, Eq. 33

The power consumption in the K components may be regulated by two control parameters: 1) the vector “z” of think times for each queue (q) 60; and 2) the workload transformation function F_{WTC} as presented in Eq. 33.

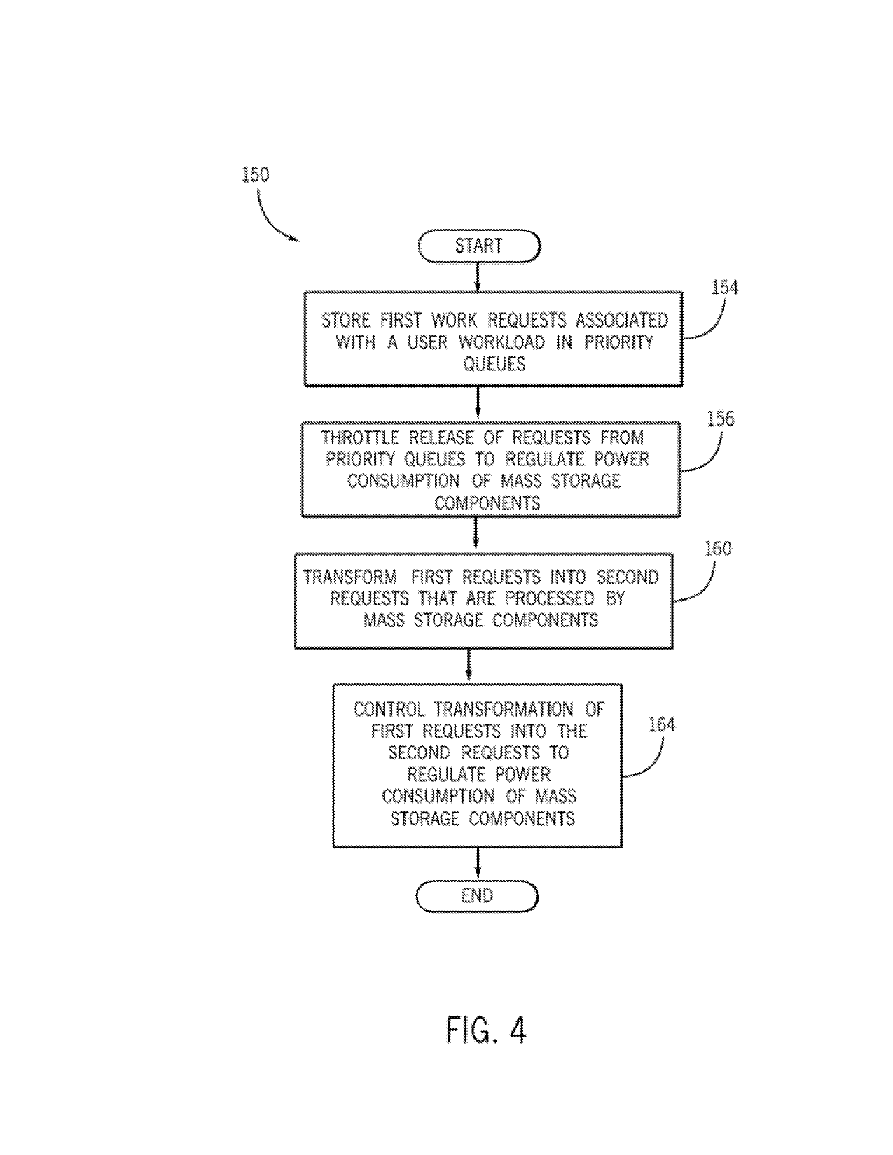

Referring to FIG. 4, to summarize, a technique 150 to conserve power in a mass storage system in accordance with implementations disclosed herein includes storing (block 154) first work requests associated with a user workload in priority queues and throttling (block 156) the release of the requests from the priority queues to regulate power consumption of mass storage components. The technique 150 further includes transforming (block 160) the first request into second requests, which are processed by the mass storage components. The transformation of the first requests into the second requests is controlled (block 164) to regulate the power consumption of the mass storage components.

It is noted that either block 156 or 164 may be omitted, as either scheme may be used for purposes of controlling power independently from the other. Thus, many variations are contemplated and are within the scope of the appended claims.

As a non-limiting specific example of a possible implementation of block 156 (i.e., Alternative 1), a disk array with 500 drives may be used to store LUNs in RAID1 mode, and it is assumed that a series of online transaction processing (OLTP) 4 kilobyte (KB) reads (queries) from the 500 Seagate ST3300656FC disk drives are executed. One important assumption for the purposes of the example is that the 500 disks are the bottleneck of the workload, not the disk array controller 52. For simplicity, it is assumed that the processing rate on each component 130 is the same (balanced workload). Therefore λ_{c1}=λ_{c2}= . . . =λ_{cK}=λ. It is assumed for this example that the power consumed by each one of the cᵢ component of all K components, P_{ci}, is equal (balanced workload), and P_{c1}λ=P_{c2}λ= . . . =λP_{cK}λ=P_{c}λ. Therefore, the total power (called “P_{K}(λ)”) consumed by the K components may be described as follows:

P_{K}(λ)=KP_{c}(λ), Eq. 34

The Seagate ST3300656FC disk drive was tested for its response time (RT) versus throughput (in terms of 4 kB input/output operations per second (IO/s) behavior. The results are summarized below in Table 1:

TABLE 1

| 4 KB IO/s | Watts | RT (ms) |
|---|---|---|
| 0 | 11 | NA |
| 50 | 12.2 | 6 |
| 100 | 13.5 | 8 |
| 150 | 14.8 | 9 |
| 200 | 15.4 | 13 |
| 250 | 15.7 | 18 |
| 300 | 15.9 | 32 |
| 350 | 16 | 50 |

With 500 disks, K=500, and assuming a cost per kilowatt hour of $0.10, the following Table 2 may be constructed based on Table 1:

TABLE 2

| | | | kW/h in 30 | |
|---|---|---|---|---|
| 4 KB IO/s | RT (ms) | kWatts/h | Days | Cost for 30 Days |
| 0 | NA | 5.50 | 3,960 | $396.00 |
| 25,000 | 6 | 6.10 | 4,392 | $439.20 |
| 50,000 | 8 | 6.75 | 4,860 | $486.00 |
| 75,000 | 9 | 7.40 | 5,328 | $532.80 |
| 100,000 | 13 | 7.70 | 5,544 | $554.40 |
| 125,000 | 18 | 7.85 | 5,652 | $565.20 |
| 150,000 | 32 | 7.95 | 5,724 | $572.40 |
| 175,000 | 50 | 8.00 | 5,760 | $576.00 |

The throttling of the 4 KB read requests down a maximum of 25,000 IO/s is achieved by using the priority queues scheme. For this example, two queues are used, and one queue has higher priority than the other queue. Queue one, q₁, can deliver up to 15,000 IO/s, and queue two, q₂, can deliver up to 10,000 IO/s. That means that the sum of the processing rate for both queues is 25,000 IO/s maximum. Using Eq. 17, L=2, λ_{q1}=15,000 and λ_{q2}=10,000, which produces the following:

X_{Q}=λ_{q1}+λ_{q2}=15,000+10,000=25,000 IO/s.

At 25,000 IO/s, each disk delivers 50 IO/s, and the response time of each disk is 0.006 seconds, or 6 ms, as depicted in Table 1. Also, for the example the number of requests in q₁ is N_{q1}150 and in q₂ is N_{q2}=150. Using E. 18 the think times are as follows:

$${z}_{1} = \frac{{N}_{q 1}}{{λ}_{q 1}} - {r}_{1} = \frac{150}{15 \text{,} 000} - .006 = 0.004 , \\ and$$

$${z}_{2} = \frac{{N}_{q 2}}{{λ}_{q 2}} - {r}_{2} = \frac{150}{10 \text{,} 000} - .006 = 0.009 .$$

Using the vector notation as in Eq. 30, the following may be described:

V_{L}(z)=[λ_{q1}(z₁),λ_{q2}(z₂)]=[15000,10000],

and

Z=[z₁,z₂]=[0.004,0.009].

The savings in terms of kilowatts per hour (kW/h) and US Dollars ($US) may be estimated if compared to another higher processing rate. For example, if the maximum rate of 25,000 IO/s is compared against the 100,000 IO/s rate, then the savings in power consumption and money are as follows:

Savings in kW/h in 30 days=5,544−4,932=1,152 kW/h,

and

Savings in $US in 30 days=$554.40−$493.20=$115.20.

As an example of a specific non-limiting implementation of block 164 of FIG. 4 (i.e., Alternative 2), the savings in power consumption may be estimated as in the previous example with the addition of the savings in power consumption by operating the processor (i.e., the processor (such as one or multiple CPUs 53 (FIG. 1)) associated with workload transforming component 110) at 300 MHz instead of its maximum frequency (for this example) at 1.2 GHz. The power consumed at that frequency is 12 watts, as opposed to the 19 watts for the maximum frequency. Therefore, a savings of 0.007 kW/h may be added to the savings presented in the example above.

Other implementations are contemplated and are within the scope of the appended claims. For example, although reducing the frequency of the processor of workload transforming component 110 is one exemplary way to control the workload transforming function (e.g., Eq. 22) for purposes of reducing power consumption, the processor may be controlled in other ways to achieve the same result. As non-limiting alternative example, a software command may be employed to place the processor in a slower mode of operation. Thus, these and other techniques may be used to slow down the transformation of Eq. 22 for purposes of reducing power consumption.

While the present invention has been described with respect to a limited number of embodiments, those skilled in the art, having the benefit of this disclosure, will appreciate numerous modifications and variations therefrom. It is intended that the appended claims cover all such modifications and variations as fall within the true spirit and scope of this present invention.

1. A method comprising:
receiving first work requests associated with a user workload;
using a machine to transform the first work requests into second work requests provided to components of a mass storage system to cause the components to perform work associated with a workload of the mass storage system; and
regulating a power consumption of the mass storage system, comprising regulating a rate at which the second work requests are provided to the components of the mass storage system.

2. The method of claim 1, further comprising:
storing the first work requests in at least one queue, wherein
the regulating comprises regulating a rate at which the first work requests are communicated from said at least one queue to a transformation engine to transform the first work requests into the second work requests.

3. The method of claim 2, wherein said at least one queue comprises multiple queues, each of the queues is associated with a rate at which first work requests stored in the queue are released to the transformation engine, and the act of regulating the rate at which the stored first work requests are communicated to the transformation engine comprises regulating the rates associated with the queues based on priorities associated with the queues.

4. The method of claim 2, wherein the act of regulating the power consumption of the mass storage system comprises controlling the transforming to regulate the rate at which the second work requests are provided to the components of the mass storage system.

5. The method of claim 1, wherein the act of regulating the power consumption of the mass storage system comprises controlling the transformation of the first work requests to regulate the rate at which the second work requests are provided to the components of the mass storage system.

6. The method of claim 5, wherein the act of controlling the transformation comprises regulating a throughput of a processor that transforms the first work requests into the second work requests.

7. An article comprising at least one machine-readable storage medium storing instructions that when executed by at least one processor cause said at least one processor to perform a method according to claim 1.

8. An apparatus comprising:
queues to receive first work requests associated with a user workload;
a transformation engine to transform the first work requests into second work requests provided to components of a mass storage system to cause the components to perform work associated with a workload of the mass storage system; and
a controller to regulate a rate at which the second work requests are provided to the components of the mass storage system to regulate a power consumption of the mass storage system.

9. The apparatus of claim 8, wherein the controller and the transformation engine are part of a disk array controller.

10. The apparatus of claim 8, wherein the mass storage comprises at least one of solid states drives, mechanical drives, and a combination of solid stages drives and mechanical drives.

11. The apparatus of claim 8, wherein the controller is adapted to regulate rates at which the first work requests stored in the queues are released to the transformation engine.

12. The apparatus of claim 11, wherein the controller regulates the rates based on priorities assigned to the queues.

13. The apparatus of claim 8, wherein the controller is adapted to control the transformation engine to regulate a rate at which the second work requests are provided to the mass storage system.

14. The apparatus of claim 13, wherein the controller is adapted to control a throughput of the transformation engine to regulate the rate at which the second work requests are provided to the mass storage system.

15. The apparatus of claim 8, wherein the transformation engine is adapted to transform the first work requests into the second work requests based on a Raid level of a logical unit being accessed.
